(19) United States
(12) Patent Application Publication
(10) Pub. No.: US 2026/0226213 A1
(43) Pub. Date: Aug. 6, 2026

(54) METHOD FOR PRODUCING POLYMER, POLYMER PRODUCTION DEVICE, AND SYSTEM FOR OPTIMIZING RADICAL POLYMERIZATION REACTION

(71) Applicants: JSR CORPORATION, Tokyo (JP); NATIONAL UNIVERSITY CORPORATION NARA INSTITUTE OF SCIENCE AND TECHNOLOGY, Ikoma-shi, Nara (JP)

(72) Inventors: Shigehito ASANO, Tokyo (JP); Tetsunori SUGAWARA, Tokyo (JP); Yu-ya OHNISHI, Tokyo (JP); Araki WAKIUCHI, Tokyo (JP); Mikiya FUJII, Ikoma-shi, Nara (JP); Hiroharu AJIRO, Ikoma-shi, Nara (JP)

(73) Assignees: JSR CORPORATION, Tokyo (JP); NATIONAL UNIVERSITY CORPORATION NARA INSTITUTE OF SCIENCE AND TECHNOLOGY, Ikoma-shi, Nara (JP)

(21) Appl. No.: 19/149,125

(22) PCT Filed: Jan. 19, 2024
(86) PCT No.: PCT/JP2024/001440

§ 371 Date: Jul. 18, 2025

(30) Foreign Application Priority Data
Jan. 19, 2023 (JP) 2023-006716

(51) Int. Cl. C08F 220/14; B01J 19/00; B01J 19/06; B01J 19/18; C08F 212/08

(52) U.S. Cl. CPC C08F 220/14; B01J 19/0006; B01J 19/0066; B01J 19/06; B01J 19/1818; C08F 212/08; B01J 2219/002; B01J 2219/00209; B01J 2219/00231; B01J 2219/00234; C08F 2400/02; C08F 2800/10

(57) ABSTRACT

Provide are a method for producing a polymer having a high purity and a highly controlled structural unit composition and molecular weight, and a polymer production device. The method for producing a polymer is a method in which a polymer is obtained by radical polymerization with an azo-based polymerization initiator, two or more monomers, and a solvent. The method includes a first step of performing the radical polymerization in a tubular reactor, and a second step of performing the radical polymerization in a stirred tank reactor after the first step, in which a maximum solid content concentration C1ₘₐₓ on a mass basis in the first step is 30 mass % or more, a maximum solid content concentration C2ₘₐₓ on a mass basis in the second step is less than 50 mass %, and the maximum solid content concentration C1ₘₐₓ and the maximum solid content concentration C2ₘₐₓ satisfy C1ₘₐₓ≥C2ₘₐₓ.

### TECHNICAL FIELD

The present invention relates to a method for producing a polymer, a polymer production device, and a system for optimizing a radical polymerization reaction.

### BACKGROUND ART

The development of high value-added materials for semiconductor applications, optics applications and the like is remarkable. Various improvements have been made. The same applies to polymer materials that are widely used as a main component. Studies have been conducted on reaction processed and reaction components to improve the quality and the functionality of polymers and increase process efficiency (for example, JP-A-2012-107163, JP-B-3341568, JP-B-3113205, JP-W-2006-511657, JP-B-6800700, JP-B-6800827, JP-B-6121963, and JP-B-5624155).

### PRIOR ART DOCUMENTS

### Patent Documents

Patent Document 1: JP-A-2012-107163
Patent Document 2: JP-B-3341568
Patent Document 3: JP-B-6800700
Patent Document 4: JP-B-6800827
Patent Document 5: JP-B-6121963
Patent Document 6: JP-B-5624155

### SUMMARY OF THE INVENTION

### Problems to be Solved by the Invention

A polymers is required to have a high purity, and in particular, a highly controlled structural unit composition (hereinafter, also referred to simply as a “composition”) and molecular weight. If a polymer contains impurities such as metal, or is not uniform in composition and molecular weight (hereinafter, also referred to collectively as “composition and the like”), this may cause defects in the end use, and induce the deterioration of the yield and performance. Conventional techniques cannot be said to sufficiently meet the above-described requirements.

An object of the present invention is to provide a method for producing a polymer having a high purity and a highly controlled structural unit composition and molecular weight, a polymer production device, and a system for optimizing a radical polymerization reaction.

### Means for Solving the Problems

In order to achieve the object, the present inventors have intensively studied, and as a result have found that the object can be achieved by employing the following features. This finding has led to the completion of the present invention.

That is, an embodiment of the present invention relates to a method for producing a polymer, wherein the polymer is obtained by radical polymerization with an azo-based polymerization initiator, two or more monomers, and a solvent, the method including:
a first step of performing the radical polymerization in a tubular reactor; and
a second step of performing the radical polymerization in a stirred tank reactor after the first step, in which
a maximum solid content concentration C1ₘₐₓ on a mass basis in the first step is 30 mass % or more (hereinafter, a concentration range set for the maximum solid content concentration C1ₘₐₓ is also referred to as a “concentration condition (i)”),
a maximum solid content concentration C2ₘₐₓ on a mass basis in the second step is less than 50 mass % (hereinafter, a concentration range set for the maximum solid content concentration C2ₘₐₓ is also referred to as a “concentration condition (ii)”),
the maximum solid content concentration C1ₘₐₓ and the maximum solid content concentration C2ₘₐₓ satisfy C1ₘₐₓ C2ₘₐₓ (hereinafter, a relationship between the maximum solid content concentration C1ₘₐₓ and the maximum solid content concentration C2ₘₐₓ is also referred to as a “concentration condition (iii)”), and
a temperature T1 [° C.] in the tubular reactor in the first step and a temperature T2 [° C.] in the stirred tank reactor in the second step satisfy |T1−T2|<20 (hereinafter, a relationship satisfied by the temperature T1 [° C.] and the temperature T2 [° C.] is also referred to as a “temperature difference condition (A)”).

In living radical polymerization which is widely used for controlling the structural unit composition and the molecular weight, there is a limit to enhancement of the purity because a metal catalyst and a sulfur atom-containing compound are present in the reaction system. In the production method, a high-purity polymer can be produced because an azo-based polymerization initiator which generates nitrogen molecules (nitrogen gas) that are easily removed is used for radical polymerization of two or more monomers.

The present inventors have conducted studies on a technique for controlling the composition and the like of a polymer in a radical polymerization system using an azo-based polymerization initiator, to which a copolymerization reaction of methyl methacrylate and styrene in which it is difficult to control the composition and the like is applied as a typical example. As a result, it has been found that surprisingly, a difference in polymerization rate between the monomers is small in a high concentration range and a low concentration range, either of which is not a monomer concentration range that is assumed in a normal industrial production process. This has led to the findings that the composition and the molecular weight of the polymer can be taken as a function of the concentration, and controlled to a certain extent.

The productivity is low even when the reaction in a low concentration range proceeds in a batch-type stirred tank reactor, the present inventors have conducted on the reaction in a high concentration range. However, it has been found that in a stirred tank reactor, it is difficult to control the temperature of the polymerization reaction in the high concentration range, particularly at the initial stage of the reaction. Thus, instead of the stirred tank reactor, a tubular reactor (so-called a flow reactor) having a high temperature controlling performance and high mixing performance has been used to try and control the polymerization reaction. However, when the polymerization reaction proceeds to some extent, a thickening action is generated by the product, and bubbles are generated by nitrogen gas coming from the azo-based polymerization initiator, so that a reaction controlling property is lost.

The present inventors have further conducted studies, and made an attempt to solve the problems associated with the respective reactors alone by combination of a tubular reactor and a stirred tank reactor. Specifically, in a tubular reactor having a high temperature controlling property and high mixing performance, a polymerization reaction particularly at the initial stage of the reaction in the high concentration range. Before the start of a stage in which a thickening action and bubbles are generated, a shift is made to a polymerization reaction in the low concentration range using a stirred tank reactor in which additional introduction and extraction of components and removal of gas are easy, and the polymerization reaction is carried out to the end while the generation of the thickening action and bubbles is suppressed.

The present inventors have examined the concentration range in each reactor and temperature control in each step along with the idea described above. As a result, it has been found that a large difference between the temperatures of the inside of the tubular reactor in the first step and the inside of the stirred tank reactor in the second step leads to appearance of two or more peaks in molecular weight distribution measurement. The present invention is based on the novel findings.

By carrying out the first step in a tubular reactor having a high temperature controlling reactor, the composition and the molecular weight of a polymer formed can be highly controlled. By carrying out the subsequent second step in a stirred tank reactor, a series of steps from the start to the end of radical polymerization can be performed seamlessly while control failure caused by generation of a thickening action and bubbles. In addition, by setting the concentration conditions (i), (ii) and (iii) and the temperature difference condition (A) within predetermined ranges, the polymerization rate can be controlled by concentration and by temperature in each step, so that a polymer having a highly controlled composition and molecular weight can be efficiently produced.

In the present specification, the term “solid content” means a monomer and a reaction product thereof (a polymer having a low polymerization degree (oligomer), a polymer and a propagating chain radical). Therefore, the solid content does not include a solvent and an azo-based polymerization initiator.

In an embodiment, the maximum solid content concentration C1ₘₐₓ and the maximum solid content concentration C2ₘₐₓ preferably satisfy C1ₘₐₓ>C2ₘₐₓ. In the production method, the reaction product after the first step is controlled to a certain extent, and therefore, as long as the concentration conditions (i) and (ii) are satisfied, the composition and the like of the polymer can be controlled even if the maximum solid content concentration C1ₘₐₓ and the maximum solid content concentration C2ₘₐₓ are equal. Further, by satisfying C1ₘₐₓ>C2ₘₐₓ as the concentration condition (iii), carrying out the first step in a relatively high concentration range, and carrying out the second step in a relatively low concentration range, the polymerization rate can be optimized in the steps, so that a polymer having a more highly controlled composition and the like can be produced.

In an embodiment, the polymerization conversion in the first step is preferably 80% or less from the viewpoint of suppressing generation of a thickening action and bubbles.

In an embodiment, the temperature T1 [° C.] and the temperature T2 [° C.] preferably satisfy |T1−T2|≤10. Further, the temperature T1 [° C.] and the temperature T2 [° C.] preferably satisfy T1≥T2. By controlling the temperature difference condition (A) in this way, a molecular weight distribution that matches characteristics required for the polymer can be given together, with a highly controlled concentration.

In an embodiment, the monomer is preferably two or more selected from the group consisting of one or more monomers which are (meth)acrylic acid or esters thereof, and one or more aromatic vinyl-based monomers. In particular, the monomer is preferably one or more monomers which are (meth)acrylic acid or esters thereof, and one or more aromatic vinyl-based monomers. In the radical polymerization of the monomers, it is difficult to control the composition and the like of a polymer obtained, but the production method is capable of efficiently producing a polymer having a highly controlled composition and the like.

In the present specification, the term “(meth) acrylic acid” means acrylic acid or methacrylic acid.

In an embodiment, the radical polymerization is preferably performed without a dormant species. By the production method, the polymerization rate of the monomer can be controlled by concentration, so that a polymer having high purity and a highly controlled composition and the like can be produced with a good yield without utilizing living radical polymerization that requires a dormant species.

In the present specification, the “dormant species” means a chemical species in which an active radical at the propagating chain end of a polymer chain is temporarily and reversibly inactivated (stabilized) as a covalent bond species.

In an embodiment, the maximum solid content concentration C1ₘₐₓ and the maximum solid content concentration C2ₘₐₓ preferably satisfy C1ₘₐₓ=C2ₘₐₓ. This enables suppression of a change in concentration of the monomer during transfer from the inside of the tubular reactor in the first step to the stirred tank reactor in the second step, so that it is possible to highly control the composition and the like of a polymer obtained. In particular, the above-mentioned condition is preferred as a concentration condition in the scale-up of a polymerization reaction which can be subjected to a significant effect of a change in concentration of the monomer.

Another embodiment of the present invention relates to a polymer production device for obtaining a polymer by radical polymerization with an azo-based polymerization initiator, two or more monomers, and a solvent, the device including, a tubular reactor and a stirred tank reactor in the following order each configured to perform the radical polymerization,
wherein
a maximum solid content concentration C1ₘₐₓ on a mass basis in the tubular reactor is 30 mass % or more,
a maximum solid content concentration C2ₘₐₓ on a mass basis in the stirred tank reactor is less than 50 mass %,
the maximum solid content concentration C1ₘₐₓ and the maximum solid content concentration C2ₘₐₓ satisfy C1ₘₐₓ≥C2ₘₐₓ, and
a temperature T1 [° C.] in the tubular reactor in the first step and a temperature T2 [° C.] in the stirred tank reactor in the second step satisfy |T1−T2|<20.

By using the polymer production device, the method for producing a polymer can be efficiently carried out, and a polymer having high purity and a highly controlled composition and the like can be produced with a high yield.

Still another embodiment of the present invention relates to a system for optimizing a radical polymerization reaction in which a polymer is obtained by radical polymerization in a reaction liquid containing a polymerization initiator, a monomer, and a solvent, the system including:
a flow channel through which the reaction liquid flows;
a feeder for supplying one or more of the polymerization initiator, the monomer, and the solvent to the flow channel;
a tubular reactor and a stirred tank reactor interposed between a starting end and a terminal end of the flow channel with the tubular reactor on a side of the starting end;
a detector for acquiring one or more measured values for the reaction liquid in at least the flow channel, the tubular reactor and the stirred tank reactor; and
a controller that is connected to the flow channel, the feeder, the tubular reactor and the stirred tank reactor, and controls one or more process parameters of each of the flow channel, the feeder, the tubular reactor and the stirred tank reactor,
the controller including:
a reception unit that receives the measured value from the detector;
an estimation unit that estimates an actual progress state of the radical polymerization from the measured value;
a condition determination unit that compares the actual progress state and an ideal progress state, and determines one or more process parameters in each of the flow channel, the feeder, the tubular reactor and the stirred tank reactor for a next unit reaction time so as to make the actual progress state close to the ideal progress state; and
a control unit that changes, in accordance with the determined process parameters, process parameters of the flow channel, the feeder, the tubular reactor and the stirred tank reactor.

The system for optimizing a radical polymerization reaction enables construction of a machine learning system capable of efficiently producing a high-quality polymer while avoiding excessive trial and error even when the type and the amount of the polymerization initiator or the monomer are changed, or scale-up of the polymerization reaction is attempted.

Specifically, the condition determination unit may determine a process parameter by using a condition setting algorism to calculate the change in the actual progress state in the next unit reaction time, which is caused by the change in the process parameter.

In an embodiment, it is preferable that the controller further includes a storage unit that stores the measured value, the actual progress state and a difference between the actual progress state and the ideal progress state before and after the process parameter is changed. By repeating acquisition of the measured value, estimation of the actual progress state, determination of the process parameter, and change of the process parameter, a machine-learning optimization system of higher precision.

The measured value may be acquired by either in-line monitoring or sampling of the reaction liquid.

In an embodiment, the controller may include an interface in which the process parameter can be manually controlled.

In an embodiment, the measured value preferably includes at least one of an optical spectrum and a viscosity of the reaction liquid from the viewpoint of correlation with the actual state of progress.

In an embodiment, the process parameter preferably includes at least one of the temperature, the introduction amount of a monomer, the introduction amount of an azo polymerization initiator, the introduction amount of a solvent, and the stirring rate.

In an embodiment, the actual progress state preferably includes at least one of an amount of consumption of a monomer and a weight average molecular weight of a polymer.

### BRIEF DESCRIPTION OF THE DRAWINGS

FIG. 1A is a schematic diagram showing an example of a polymer production device.

FIG. 1B is a schematic diagram showing another example of a polymer production device.

FIG. 2 is a block diagram schematically showing a system for optimizing a radical polymerization reaction.

FIG. 3A is a graph showing a monomer composition ratio over time in a second step of Example 9.

FIG. 3B is a graph showing a monomer composition ratio over time in a second step of Example 10.

FIG. 3C is a graph showing a monomer composition ratio over time in a second step of Example 11.

FIG. 3D is a graph showing a monomer composition ratio over time in a second step of Example 12.

FIG. 3E is a graph showing a monomer composition ratio over time in a second step of Example 13.

FIG. 3F is a graph showing a monomer composition ratio over time in a second step of Example 14.

FIG. 3G is a graph showing a monomer composition ratio over time in a second step of Example 15.

FIG. 3H is a graph showing a monomer composition ratio over time in a second step of Example 16.

### MODE FOR CARRYING OUT THE INVENTION

Hereinbelow, embodiments of the present disclosure will be described in detail, but the present disclosure is not limited to these embodiments.

### <Method for Producing Polymer>

For a method for producing a polymer according to the present embodiment, components used for radical polymerization, a polymer production device, and steps will be described in order.

### (Azo-Based Polymerization Initiator)

As the azo-based polymerization initiator, a known azo-based polymerization initiator can be used. Examples of the azo-based polymerization initiator include 2,2′-azobis(isobutyronitrile) (AIBN), 2,2′-azobis(2-methylbutyronitrile) (AMBN), 2,2′-azobis(2,4-dimethylvaleronitrile) (ADVN), 1,1′-azobis(1-cyclohexanecarbonitrile) (ACHN), dimethyl-2,2′-azobisisobutyrate (MAIB), 4,4′-azobis(4-cyanovaleric acid) (ACVA), 1,1′-azobis(1-acetoxy-1-phenylethane), 2,2′-azobis (2-methylbutyramide), 2,2′-azobis(4-methoxy-2,4-dimethylvaleronitrile), 2,2′-azobis(2-methylamidinopropane) dihydrochloride, 2,2′-azobis[2-(2-imidazolin-2-yl)propane], 2,2′-azobis[2-methyl-N-(2-hydroxyethyl)propionamide], 2,2′-azobis(2,4,4-trimethylpentane), 2-cyano-2-propylazoformamide, 2,2′-azobis(N-butyl-2-methylpropionamide), and 2,2′-azobis(N-cyclohexyl-2-methylpropionamide). The azo-based polymerization initiators may be used singly or in combination of two or more thereof.

The 5-minute half-life temperature of the azo-based polymerization initiator is not particularly limited, but is preferably 40° C. or higher and 120° C. or lower. By setting the 5-minute half-life temperature within the above-described temperature range, handleability is improved, and decomposition in regions other than heating regions (polymerization reaction regions) is suppressed to make the decomposition occur in the heating regions (polymerization reaction regions), so that a polymer having a highly controlled composition and molecular weight can be efficiently produced.

The 5-minute half-life temperature is a temperature at which the ratio of decomposition of the azo-based polymerization initiator becomes 50% in 5 minutes. The 5-minute half-life temperature can be determined from a reaction rate constant, i.e., the Arrhenius equation, with the use of the 10 hour half-life temperature and the activation energy of the azo polymerization initiator.

Examples of the azo-based polymerization initiator having a 5-minute half-life temperature of 60 to 120° C. include dimethyl-2,2′-azobisisobutyrate (5-minute half-life temperature: 107° C.), 2,2′-azobis(2,4-dimethylvaleronitrile) (5-minute half-life temperature: 90° C.), 2,2′-azobis(4-methoxy-2,4-dimethylvaleronitrile) (5-minute half-life temperature: 66° C.), and 2,2′-azobisisobutyronitrile (5-minute half-life temperature: 104° C.).

The blending amount of the azo-based polymerization initiator is not limited as long as it allows the radical polymerization of the monomer to proceed sufficiently. The lower limit of the blending amount is preferably 0.5 mol %, more preferably 1 mol %, still more preferably 2 mol %, and particularly preferably 3 mol % with respect to the total amount of the monomers. The upper limit of the blending amount is preferably 15 mol %, more preferably 10 mol %, still more preferably 8 mol %, and particularly preferably 6 mol %.

### (Monomer)

In the production method, as the monomer, two or more monomers are used. As the monomer, either a known ethylenically unsaturated bond-(carbon-carbon double bond)-containing compound or acetylenically unsaturated bond-(carbon-carbon triple bond)-containing compound that can be subjected to an addition polymerization reaction in radical polymerization can be used, but an ethylenically unsaturated bond-containing compound is preferable.

The ethylenically unsaturated bond-containing compound is preferably two or more selected from the group consisting of one or more monomers which are (meth)acrylic acid or esters thereof (hereinafter, also referred to as a “monomer (1)”), and one or more aromatic vinyl-based monomers (hereinafter, also referred to as a “monomer (2)”). As the monomer, two or more monomers (1) may be used, one or more monomers (1) and one or more monomers (2) may be combined, or two or more monomers (2) may be used. The monomer is preferably one or more monomers (1) and one or more monomers (2).

### (Monomer (1))

The monomer (1) is a monomer which is (meth)acrylic acid or an ester thereof. As the ester of (meth)acrylic acid, a (meth)acrylate obtained by replacing a hydrogen atom of a carboxy group of (meth)acrylic acid with a substituent can be preferably utilized.

Examples of the (meth)acrylate as the monomer (1) include (meth)acrylates having a chain alkyl group (a linear alkyl group or branched alkyl group), (meth)acrylates having a cyclic alkyl group, (meth)acrylates having a polycyclic structure, (meth)acrylates having an aromatic group, (meth)acrylates having a polyalkylene glycol structural unit, (meth)acrylates having a hydroxy group, (meth)acrylates having a lactone-modified hydroxy group, (meth)acrylates having an alkoxy group, (meth)acrylates having an oxygen-containing heterocyclic group, (meth)acrylates having an acidic group, and (meth)acrylic acid. Of these, one may be used, or two or more may be used in combination.

The (meth)acrylate having a linear alkyl group is preferably a (meth)acrylate having a linear alkyl group in which the linear alkyl group has 1 to 20 carbon atoms, more preferably a (meth)acrylate having a linear alkyl group in which the linear alkyl group has 1 to 10 carbon atoms, and still more preferably a (meth)acrylate having a linear alkyl group in which the linear alkyl group has 1 to 5 carbon atoms. Examples of the (meth)acrylate having a linear alkyl group include methyl (meth)acrylate, ethyl (meth)acrylate, n-propyl (meth)acrylate, n-butyl (meth)acrylate, n-pentyl(meth) acrylate, n-hexyl (meth)acrylate, n-octyl (meth)acrylate, n-nonyl (meth)acrylate, decyl (meth)acrylate, n-lauryl (meth)acrylate, and n-stearyl (meth)acrylate.

The (meth)acrylate having a branched alkyl group is preferably a (meth)acrylate having a branched alkyl group in which the branched alkyl group has 3 to 20 carbon atoms, and more preferably a (meth)acrylate having a branched alkyl group in which the branched alkyl group has 3 to 10 carbon atoms. Examples of the (meth)acrylate having a branched alkyl group include isopropyl (meth)acrylate, isobutyl (meth)acrylate, sec-butyl (meth)acrylate, tert-butyl (meth)acrylate, isooctyl (meth)acrylate, 2-ethylhexyl (meth)acrylate, isononyl (meth)acrylate, and isodecyl (meth)acrylate.

The (meth)acrylate having a cyclic alkyl group is preferably a (meth)acrylate having a cyclic alkyl group in which the cyclic alkyl group has 6 to 12 carbon atoms. Examples of the cyclic alkyl group include cyclic alkyl groups having a monocyclic structure (for example, cycloalkyl groups). Specific examples of the (meth)acrylate having a cyclic alkyl group of monocyclic structure include cyclohexyl (meth)acrylate, methylcyclohexyl (meth)acrylate, and cyclododecyl (meth)acrylate.

The (meth)acrylate having a polycyclic structure is preferably a (meth)acrylate having a polycyclic structure in which the polycyclic structure has 6 to 12 carbon atoms. Examples of the polycyclic structure include cyclic alkyl groups having a bridged ring structure (for example, an adamantyl group, a norbornyl group, and an isobornyl group). Specific examples of the (meth)acrylate having a polycyclic structure include isobornyl (meth)acrylate, dicyclopentenyloxyethyl (meth)acrylate, dicyclopentanyloxyethyl (meth)acrylate, 2-methyl-2-adamantyl (meth)acrylate, and 2-ethyl-2-adamantyl (meth)acrylate.

The (meth)acrylate having an aromatic group is preferably a (meth)acrylate having an aromatic group in which the aromatic group has 6 to 12 carbon atoms, and more preferably a (meth)acrylate having an aromatic group in which the aromatic group has 6 to 9 carbon atoms. Examples of the aromatic group include an aryl group, an alkylaryl group, an aralkyl group, an aryloxy group, an aryloxyalkyl group, an alkylaryloxy group, and an aralkyloxy group. In particular, a phenyl group, a benzyl group, a tolyl group, and a phenoxyethyl group are preferable. Specific examples of the (meth)acrylate having an aromatic group include benzyl (meth)acrylate, phenyl (meth)acrylate, and phenoxyethyl (meth)acrylate.

Examples of the (meth)acrylate having a polyalkylene glycol structural unit include (meth)acrylates having a polyethylene glycol structural unit, such as polyethylene glycol (polymerization degree=2 to 10) methyl ether (meth)acrylate, polyethylene glycol (polymerization degree=2 to 10) ethyl ether (meth)acrylate, polyethylene glycol (polymerization degree=2 to 10) propyl ether (meth)acrylate, and polyethylene glycol (polymerization degree=2 to 10) phenyl ether (meth)acrylate; and (meth)acrylates having a polypropylene glycol structural unit, such as polypropylene glycol (polymerization degree=2 to 10) methyl ether (meth)acrylate, polypropylene glycol (polymerization degree=2 to 10) ethyl ether (meth) acrylate, polypropylene glycol (polymerization degree=2 to 10) propyl ether (meth)acrylate, and polypropylene glycol (polymerization degree=2 to 10) phenyl ether (meth)acrylate.

The (meth)acrylate having a hydroxy group is preferably a hydroxyalkyl (meth)acrylate. The number of carbon atoms in the hydroxyalkyl group of the hydroxyalkyl (meth)acrylate is preferably 1 to 10, and more preferably 1 to 5. The hydroxyalkyl group may be linear or branched, and preferably has one hydroxy group. Specific examples of the (meth)acrylate having a hydroxy group include 2-hydroxyethyl (meth)acrylate, 3-hydroxypropyl (meth)acrylate, 2-hydroxypropyl (meth)acrylate, 4-hydroxybutyl (meth)acrylate, 6-hydroxyhexyl (meth)acrylate, 8-hydroxyoctyl (meth)acrylate, 10 hydroxydecyl (meth)acrylate, and 12 hydroxylauryl (meth)acrylate.

Examples of the (meth)acrylate having a lactone-modified hydroxy group include the (meth)acrylates having a hydroxy group, to which a lactone, preferably caprolactone, is added. The addition amount of caprolactone is preferably 1 mol to 10 mol, and more preferably 1 mol to 5 mol. The (meth)acrylate having a lactone-modified hydroxy group is preferably 2-hydroxyethyl (meth)acrylate to which 1 mol of caprolactone is added, 2-hydroxyethyl (meth)acrylate to which 2 mol of caprolactone is added, 2-hydroxyethyl (meth)acrylate to which 3 mol of caprolactone is added, 2-hydroxyethyl (meth)acrylate to which 4 mol of caprolactone is added, 2-hydroxyethyl (meth)acrylate to which 5 mol of caprolactone is added, 2-hydroxyethyl (meth)acrylate to which 10 mol of caprolactone is added, or the like.

Examples of the (meth)acrylate having an alkoxy group include methoxyethyl (meth)acrylate, ethoxyethyl (meth)acrylate, and phenoxyethyl (meth)acrylate.

The (meth)acrylate having an oxygen-containing heterocyclic group is preferably a (meth)acrylate having a 4- to 6-membered ring oxygen-containing heterocyclic group. Specific examples of the (meth)acrylate having an oxygen-containing heterocyclic group include glycidyl (meth)acrylate, tetrahydrofurfuryl (meth)acrylate, (3-ethyloxetane-3-yl)methyl (meth)acrylate, (2-methyl-2-ethyl-1,3-dioxolane-4-yl)methyl (meth)acrylate, cyclic trimethylolpropane formal (meth)acrylate, 2-[(2-tetrahydropyranyl)oxy]ethyl (meth)acrylate, and 1,3-dioxane-(meth)acrylate.

Examples of the acidic group include a carboxy group (—COOH), a sulfonic acid group (—SO₃H), a phosphoric acid group (—OPO₃H2), a phosphonic acid group (—PO₃H2), and a phosphinic acid group (—PO2H2). Examples of the (meth)acrylate having an acidic group include (meth)acrylates having a carboxy group, such as monomers obtained by reacting an acid anhydride such as maleic anhydride, succinic anhydride or phthalic anhydride with hydroxyalkyl (meth)acrylate; (meth) acrylates having a sulfonate group, such as ethyl sulfonate (meth)acrylate; and (meth)acrylates having a phosphate group, such as 2-(phosphonooxy) ethyl (meth)acrylate.

### (Monomer (2))

The monomer (2) is an aromatic vinyl-based monomer. The aromatic vinyl-based monomer is not particularly limited as long as it is a compound in which a vinyl group or a vinylidene group is bonded to an aromatic ring, and examples thereof include styrene-based monomers such as styrene, vinyltoluene, methoxystyrene, α-methylstyrene, α-hydroxymethylstyrene, and α-hydroxyethylstyrene; polycyclic aromatic hydrocarbon ring vinyl-based monomers such as 2-vinylnaphthalene; and aromatic heterocyclic vinyl-based monomers such as N-vinylcarbazole, 2-vinylpyridine, vinylimidazole and vinylthiophene. Of these, styrene-based monomers are preferable. The styrene-based monomer includes not only styrene but also styrene derivatives in which any substituent is bonded to the polymerizable double bond carbon or the benzene ring of styrene, and examples of the substituent include an alkyl group, an alkoxy group, a hydroxy group, a halogen group, an amino group, a nitro group, and a sulfo group. The number of carbon atoms in the alkyl group and the alkoxy group bonded to styrene is preferably 1 to 4, and more preferably 1 to 2, and at least a part of hydrogen atoms in the alkyl group and the alkoxy group bonded to styrene may be replaced with a hydroxy group or a halogen group. The styrene-based monomer is preferably unsubstituted styrene in which a substituent is not bonded to the polymerizable double bond carbon or the benzene ring of styrene.

The blending ratio of each monomer may be appropriately set according to characteristics required for the polymer. The lower limit of the blending ratio of the monomer (1) (the total blending ratio when a plurality of monomers (1) are present) to the total blending amount of the monomer (1) and the monomer (2) may be, for example, 1 mol %, 2 mol %, 3 mol %, 5 mol %, 8 mol %, 10 mol %, 20 mol %, 30 mol %, 40 mol %, or 45 mol %. The upper limit of the blending ratio of the monomer (1) may be 99 mol %, 98 mol %, 97 mol %, 95 mol %, 92 mol %, 90 mol %, 80 mol %, 70 mol %, 60 mol %, or 55 mol %. The blending ratios of the monomer (1) and the monomer (2) may be the same (i.e., each of which may be 50 mol %).

### (Solvent)

The solvent is not particularly limited as long as it is a solvent capable of dissolving or dispersing at least the azo-based polymerization initiator and the monomer.

Examples of the solvent include an alcohol-based solvent, an ether-based solvent, a ketone-based solvent, an amide-based solvent, an ester-based solvent, a hydrocarbon-based solvent, a halogen-based solvent, a nitrile-based solvent, and a sulfoxide-based solvent.

Examples of the alcohol-based solvent include:
monoalcohol-based solvents having 1 to 18 carbon atoms, such as iso-propanol, 4-methyl-2-pentanol, 3-methoxybutanol, n-hexanol, 2-ethylhexanol, furfuryl alcohol, cyclohexanol, 3,3,5-trimethylcyclohexanol, and diacetone alcohol;
polyhydric alcohol-based solvents having 2 to 18 carbon atoms, such as ethylene glycol, 1,2-propylene glycol, 2-methyl-2,4-pentanediol, 2,5-hexanediol, diethylene glycol, dipropylene glycol, triethylene glycol, and tripropylene glycol; and
partially etherized polyhydric alcohol-based solvents resulting from etherification of some of the hydroxy groups of the above-described polyhydric alcohol-based solvents.

Examples of the ether-based solvent include:
dialkyl ether-based solvents, such as diethyl ether, dipropyl ether, and dibutyl ether;
cyclic ether-based solvents such as tetrahydrofuran and tetrahydropyran;
aromatic ring-containing ether-based solvents, such as diphenyl ether and anisole (methyl phenyl ether); and
polyhydric alcohol ether-based solvents resulting from etherification of hydroxy groups of the above-described polyhydric alcohol-based solvent.

Examples of the ketone-based solvent include:
chain ketone-based solvents, such as acetone, butanone, and methyl-iso-butyl ketone;
cyclic ketone-based solvents, such as cyclopentanone, cyclohexanone, and methylcyclohexanone; and
2,4-pentanedione, acetonylacetone, and acetophenone.

Examples of the amide-based solvent include:
a cyclic amide-based solvent, such as N,N′-dimethylimidazolidinone and N-methylpyrrolidone; and
chain amide-based solvents, such as N-methylformamide, N,N-dimethylformamide, N,N-diethylformamide, acetamide, N-methylacetamide, N,N-dimethylacetamide, and N-methylpropionamide.

Examples of the ester-based solvent include:
monocarboxylate ester-based solvents, such as ethyl acetate, n-butyl acetate and ethyl lactate;
partially etherized polyhydric alcohol acetate-based solvents, such as diethylene glycol mono-n-butyl ether acetate, propylene glycol monomethyl ether acetate, and dipropylene glycol monomethyl ether acetate;
lactone-based solvents, such as y-butyrolactone and valerolactone;
carbonate-based solvents, such as diethyl carbonate, ethylene carbonate, and propylene carbonate; and
polyvalent carboxylic acid diester-based solvents, such as propylene glycol diacetate, methoxy triglycol acetate, diethyl oxalate, ethyl acetoacetate, ethyl lactate, and diethyl phthalate.

Examples of the hydrocarbon-based solvent include:
aliphatic hydrocarbon-based solvents, such as n-hexane, cyclohexane, and methylcyclohexane; and
aromatic hydrocarbon-based solvents, such as benzene, toluene, di-iso-propylbenzene, and n-amylnaphthalene.

Examples of the halogen-based solvent include dichloromethane, trichloromethane, and tetrachloromethane.

Examples of the nitrile-based solvent include acetonitrile and propionitrile.

Examples of the sulfoxide-based solvent include dimethyl sulfoxide and tetrahydrothiophene 1,1-dioxide.

The mixing ratio of the monomer (total amount) and the solvent may be appropriately set so as to obtain a later-described maximum solid content concentration. The lower limit of the ratio of the mass m1 of the solvent to the total mass m2 of the monomers (m1/m2) may be 0.5, may be 1, may be 1.5, or may be 2. The upper limit of the ratio (m1/m2) may be 10, may be 9.5, may be 9, may be 8.5, or may be 8.

### (Properties of Polymer)

The molecular weight of the polymer obtained is not particularly limited, and may be appropriately set according to required characteristics. The lower limit of the polystyrene-equivalent weight average molecular weight (Mw) of the polymer as measured by gel permeation chromatography (GPC) may be 1,000, 2,000, 3,000, 4,000, 5,000, 8,000 or 10,000. The upper limit of the weight average molecular weight may be 100,000, 80,000, 50,000, 30,000, 20,000, or 15,000.

The ratio of Mw to the polystyrene-equivalent number average molecular weight (Mn) (Mw/Mn) in the polymer as measured by GPC is preferably 1 or more and 2 or less, more preferably 1 or more and 1.9 or less, still more preferably 1 or more and 1.8 or less, and particularly preferably 1 or more and 1.6 or less.

The method for measuring Mw and Mn of the polymer is as described in Examples.

### <Polymer Production Device>

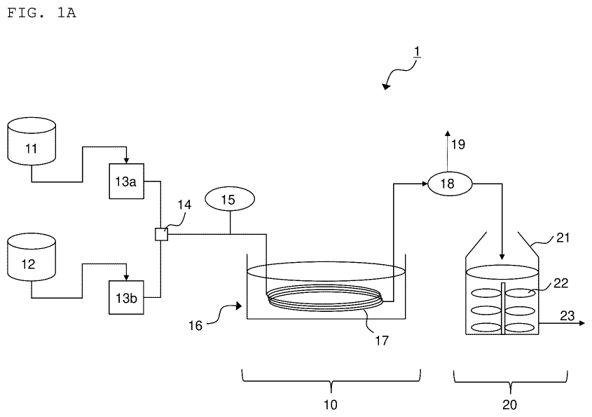

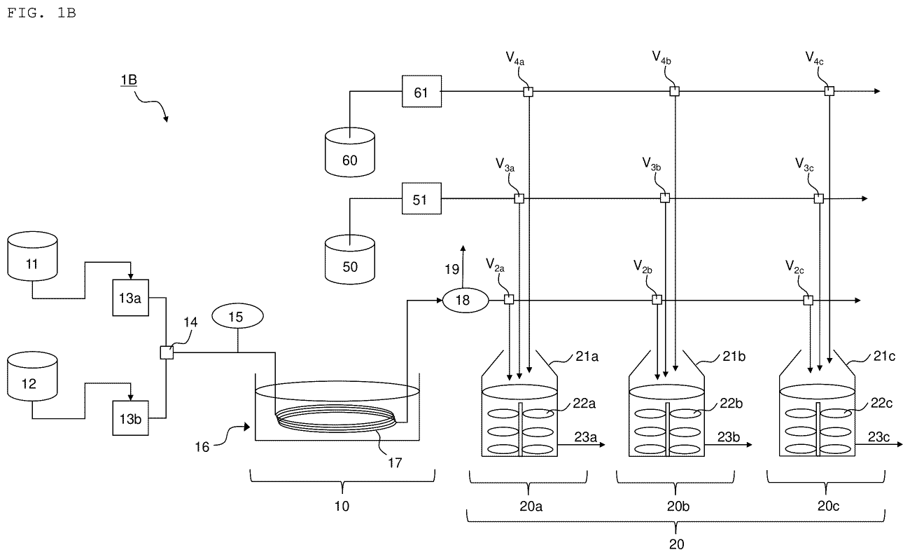

Various embodiments of the polymer production device will be described with reference to FIGS. 1A and 1B. FIG. 1A is a schematic diagram showing an example of the polymer production device. FIG. 1B is a schematic diagram showing another example of the polymer production device. Polymer production devices 1 and 1B include a tubular reactor 10 and a stirred tank reactor 20 in the stated order, and radical polymerization of monomers is performed in each of the tubular reactor 10 and the stirred tank reactor 20. In FIG. 1A, one stirred tank reactor 20 is provided, and in FIG. 1B, three stirred tank reactors 20 (20a, 20b, 20c) are provided. Hereinafter, the present invention will be described in line with the schemes of the drawings.

### First Embodiment

The polymer production device 1 shown in FIG. 1A includes, upstream from the tubular reactor 10, an initiator tank 11 which is filled with a solution containing an azo-based polymerization initiator in a solvent, a monomer tank 12 which is filed with a mixed solution containing a monomer (1) and a monomer (2) in a solvent, a collecting tube 14 provided at a junction of flow channels extending, respectively, from the initiator tank 11 and the monomer tank 12, metering pumps 13a and 13b existing in flow channels between the initiator tank 11 and monomer tank 12 and the collecting tube 14, respectively, and the collecting tube 14. The tubular reactor 10 includes a coiled flow channel 17 that extends from the collecting tube 14 and is immersed in an oil bath 16. The polymer production device 1 further includes a pressure gauge 15 connected to a flow channel between the collecting tube 14 and the coiled flow channel 17, and a three-port valve 18 extending from the coiled flow channel 17 at one end, connected to the stirred tank reactor 20 at another end, and connected to a discharge port 19 at another end. The oil bath 16 includes a temperature controller (not shown) including a thermometer and a heater. The power of the heater is adjusted according to temperature information from the thermometer.

The flow channel is a tube connecting a starting end at which a starting material solution is supplied and a terminal end at which the polymer is discharged to the stirred tank reactor 20. Examples of the cross-section shape of the tube include a circular shape, an elliptic shape, a triangular shape, a quadrangular shape, and a hexagonal shape, with a circular shape being preferable. When the cross-section of the rube is circular, the cross-section dimension (inner diameter) may be appropriately determined within a range of 0.1 mm or more and 100 mm or less with a flow rate, heat conduction efficiency and the like taken into consideration. The number of flow channels may be 1, or 2 or more. A plurality of flow channels may be merged in the middle, or one flow channel may be branched into a plurality of flow channels in the middle.

In the polymer production device 1 shown in FIG. 1A, one monomer tank 12 for storing the mixed solution of the monomers (1) and (2) is provided, but the mixed solution of the monomers (1) and (2) may be separated and stored in two or more monomer tanks. The monomer (1) and the monomer (2) may be stored in separate monomer tanks. The initiator tank 11 may also be separated and stored in two or more initiator tanks. A solvent tank in which only a solvent is stored may be separately provided.

Examples of the metering pumps 13a, 13b and 13c include a syringe pump, a plunger pump, a tube pump, and a diaphragm pump.

In the collecting tube 14, the monomers (1) and (2) and the azo-based polymerization initiator are mixed. The junction of two flow channels is not limited to one area, which is, for example, the collecting tube 14. One or both of the flow channels from the monomer tank and the initiator tank may branch and merge at two or more areas. A mixer may be provided at the junction.

The coiled flow channel 17 is immersed in the oil bath 16, and the contents of the inside of the flow channel are heated in the immersion region, whereby the radical polymerization reaction of the monomers proceeds. Therefore, the junction of the flow channels is preferably provided on the way to the oil bath 16. Instead of the oil bath 16, a known heater such as a ribbon heater or a mantle heater can be used. The structure of the tubular reactor 10 is not limited to a coiled structure typified by the coiled flow channel 17. Any structure can be applied such as a corrugated structure, a structure obtained by continuously arranging U-shaped tubes in which an end is connected to an end of another U-shaped tube, and a structure obtained by branching a main tube into a plurality of narrow tubes, which merge into the main tube again.

The length of the immersion region (heating region) where the coiled flow channel 17 is immersed in the oil bath 16 can be appropriately set within a range of 0.1 m or more and 100 m or less according to a reaction time of radical polymerization, a polymerization conversion, and the like.

The number of the coiled flow channels 17 is typically 1, but two or more coiled flow channels 17 may be provided by branching the flow channel from the collecting tube 14.

A temperature controller may be separately provided in the flow channel between the tubular reactor 10 and the stirred tank reactor 20.

The stirred tank reactor 20 includes a tank-shaped container 21 that receives the reactant solution from the tubular reactor 10, a stirring blade 22 and a temperature controller (not shown) provided in the tank-shaped container 21, and a discharge tube 23 extending from the tank-shaped container 21 to the outside.

As the tank-shaped container 21, a known reaction vessel such as a flask or a reaction tank can be used depending on a scale. The capacity of the tank-shaped container 21 can also be appropriately set within a range of 0.01 L or more and 100 L or less according to a scale.

The number of openings of the tank-shaped container 21 that receives the flow channel from the tubular reactor 10 is not limited to 1, and may be 2 or more. When the number of openings of the tank-shaped container 21 is more than 1, some openings may be openings that receive a flow channel from the tubular reactor 10, and the other openings may be introduction ports through which an additional monomer solution, an azo polymerization initiator solution, or the like is introduced. The tank-shaped container 21 is preferably closable so that the internal atmosphere can be controlled.

The shape and the number of the stirring blades 22 are not particularly limited as long as they can sufficiently mix and stir a reaction liquid in the tank-shaped container 21. Instead of the stirring blade 22 or together with the stirring blade 22, a stirrer, a baffle plate, or a water jetting device may be provided.

After completion of the polymerization reaction in the stirred tank reactor 20, the polymer obtained is discharged to the outside through the discharge tube 23.

The number of stirred tank reactors 20 may be 1 as shown in FIG. 1A, or may be 2 or more. When a plurality of stirred tank reactors 20 are installed, the flow channel from the coiled flow channel 17 may be branched so as to distribute a reactant to each stirred tank reactor 20, or adjacent stirred tank reactors 20 may be connected by the discharge tube 23 to form a continuous stirred tank reactor 20. The case of installation of a plurality of stirred tank reactors 20 will be described later with reference to FIG. 1B.

The materials of the tanks, the flow channels and the reactors are not particularly limited as long as they have excellent durability, corrosion resistance and thermal conductivity. Typical examples thereof include stainless steel, silicone resin, and fluorinated resin.

### (First Step)

In the first step, the radical polymerization is performed in the tubular reactor 10. The azo-based polymerization initiator solution fed from the initiator tank 11, and the mixed solution of the monomers (1) and (2) which is fed from the monomer tank 12 are mixed in the collecting tube 14, and radical polymerization of the resulting mixed liquid proceeds in an immersion region (heating region) of the coiled flow channel 17 in the oil bath 16. In general, the length of the coiled flow channel 17 is sufficiently larger than the inner diameter of the coiled flow channel 17, and heat is rapidly transferred between the inside and the outside of the coiled flow channel 17. Therefore, the temperature of the inside of the tubular reactor 10 (coiled flow channel 17) can be considered to be substantially identical to the temperature of the oil bath 16. The temperature of the inside of the tubular reactor 10 (heating region) is only required to be linked to the start and the progress of the radical polymerization reaction. The lower limit of the temperature of the inside of the tubular reactor 10 (heating region) is preferably 50° C., more preferably 55° C., and still more preferably 60° C. The upper limit of the temperature is preferably 120° C., more preferably 100° C., and still more preferably 80° C.

The reaction time (retention time) of the radical polymerization reaction and the flow rate of the mixture in the immersion region (heating region) of the coiled flow channel 17 can be appropriately set by considering suppression of generation of a thickening action and bubbles in the first step, the polymerization conversion, and the like. If the reaction time is extremely long or the flow rate is extremely low, there is a productivity problem, and if the retention time is extremely short or the flow rate is extremely high, the reaction liquid may pass without reaching a predetermined temperature. The flow rate of the azo-based polymerization initiator solution fed from the initiator tank 11, and the flow rate of the mixed solution of the monomers (1) and (2) which is fed from the monomer tank 12 may be appropriately set so as to obtain a mixing ratio of the monomers (1) and (2) and the azo-based polymerization initiator and a desired reaction time.

The maximum solid content concentration C1ₘₐₓ on a mass basis in the first step is only required to be 20 mass % or more. The lower limit of the maximum solid content concentration C1ₘₐₓ is preferably 25% by mass, more preferably 30% by mass, even more preferably 40% by mass, and particularly preferably 50% by mass. The upper limit of the solid content concentration C1ₘₐₓ is preferably 95% by mass, more preferably 90% by mass, still more preferably 85% by mass, and particularly preferably 80% by mass. The maximum solid content concentration C1ₘₐₓ is typically a solid content concentration at a start point (gas-liquid interface) of the immersion region (heating region) where the coiled flow channel 17 is immersed in the oil bath 16. When the monomer or the azo-based polymerization initiator is additionally supplied from an area other than the initiator tank 11 and the monomer tank 12 shown in FIG. 1A, the high solid content concentration C1ₘₐₓ may be different from the solid content concentration at the start point of the heating region. A person skilled in the art can appropriately determine the maximum solid content concentration C1ₘₐₓ (and the associated area).

The upper limit of the polymerization conversion after the first step is preferably 80%, more preferably 75%, still more preferably 70%, and particularly preferably 65%. The lower limit of the polymerization conversion in the first step is preferably 30%, more preferably 35%, still more preferably 40% or less, and particularly preferably 45%.

For evaluating the polymer obtained in the first step or a reaction liquid containing the polymer, the reaction liquid may be extracted from the discharge port 19 extending from the three-port valve 18.

### (Second Step)

In the second step, after the first step, the radical polymerization is performed in the stirred tank reactor 20. By carrying out the second step as an aging reaction (follow-up reaction), the radical polymerization reaction can be made to proceed sufficiently. Therefore, the polymerization conversion after the second step is preferably 100%, but the upper limit of the polymerization conversion may be 99.5%, may be 99%, or may be 98%.

The stirring rate can be appropriately set according to a concentration of the reaction liquid, a degree of progress of the polymerization reaction, and the like. For example, when the stirring member is a stirring blade, the lower limit of the stirring rate is preferably 50 rpm, more preferably 100 rpm, and still more preferably 200 rpm. The upper limit of the stirring rate is preferably 1,000 rpm, more preferably 800 rpm, and still more preferably 500 rpm.

For the temperature of the inside of the stirred tank reactor 20, the lower limit of the temperature is preferably 50° C., more preferably 55° C., and still more preferably 60° C. The upper limit of the temperature is preferably 100° C., more preferably 80° C., and still more preferably 70° C. The temperature of the inside of the stirred tank reactor 20 is preferably set so as to satisfy a later-described difference between the temperature and a temperature of the inside of the tubular reactor 10 in the first step.

The reaction time in the stirred tank reactor 20 can be appropriately set by considering the polymerization conversion and the like. The lower limit of the reaction time may be 10 minutes, 20 minutes, 30 minutes, 40 minutes, or 50 minutes. The upper limit of the reaction time may be 300 minutes, 250 minutes, 200 minutes, 180 minutes, 150 minutes, or 120 minutes.

The maximum solid content concentration C2ₘₐₓ on a mass basis in the second step is less than 80 mass %. The upper limit of the solid content concentration C2ₘₐₓ is preferably 60% by mass, more preferably 50% by mass, still more preferably 40% by mass, and particularly preferably 30% by mass. The lower limit of the maximum solid content concentration C1ₘₐₓ is preferably 5% by mass, more preferably 10% by mass, even more preferably 15% by mass, and particularly preferably 20% by mass. The maximum solid content concentration C2ₘₐₓ is typically a solid content concentration during introduction into the stirred tank reactor 20. When the monomer or the azo-based polymerization initiator is additionally supplied to the stirred tank reactor 20, or the solvent is removed, the high solid content concentration C2ₘₐₓ may be different from the solid content concentration during the introduction. A person skilled in the art can appropriately determine the maximum solid content concentration C2ₘₐₓ (and the associated time).

For evaluating the progress state of the polymerization reaction in the second step, the reaction liquid may be extracted from the discharge port 23 at an appropriate stage after the start of the reaction.

### (Relationship Between First Step and Second Step)

The temperature T1 [° C.] of the inside of the tubular reactor in the first step and the temperature T2 [° C.] of the inside of the stirred tank reactor in the second step satisfy |T1−T2|<20. This enables the obtainment of a polymer having one peak in molecular weight distribution measurement. The temperature T1 [° C.] and the temperature T2 [° C.] preferably satisfy |T1−T2|≤10, and more preferably satisfy T1≥T2. As a result, the structural unit composition and the target molecular weight can be controlled at a high level.

The maximum solid content concentration C1ₘₐₓ and the maximum solid content concentration C2ₘₐₓ are set so as to satisfy C1ₘₐₓ≥C2ₘₐₓ. The maximum solid content concentration C1ₘₐₓ and the maximum solid content concentration C2ₘₐₓ preferably satisfy C1ₘₐₓ>C2ₘₐₓ, more preferably satisfy C1ₘₐₓ>C2ₘₐₓ+10 mass %, further preferably satisfy C1ₘₐₓ>C2ₘₐₓ+15 mass %, and particularly preferably satisfy C1ₘₐₓ>C2ₘₐₓ+20 mass %.

It is also preferable that the maximum solid content concentration C1ₘₐₓ and the maximum solid content concentration C2ₘₐₓ satisfy C1ₘₐₓ=C2ₘₐₓ. Even when the reaction is influenced by a change in concentration of the monomer upon transfer from the inside of the tubular reactor 10 in the first step to the stirred tank reactor 20 in the second step, or scale-up occurs, the target polymer can be produced by satisfying the concentration condition (iii). For satisfying C1ₘₐₓ=C2ₘₐₓ, the reaction liquid discharged from the tubular reactor 10 in the first step is typically introduced directly as the reaction liquid in the stirred tank reactor 20 in the second step. Therefore, in this case, it is preferable that none of components including the monomer solution and the solvent is present in the stirred tank reactor 20 before introduction of the reaction liquid from the first step.

In both the first step and the second step, the radical polymerization is preferably performed without a dormant species. Examples of the polymerization reaction via a dormant species include polymerization with nitroxide (NMP), atom transfer radical addition reaction (ATRA) or atom transfer radical polymerization (ATRP) with an alkyl halide and a transition metal catalyst, and reversible chain transfer agent (RAFT) polymerization using a thiocarbonyl compound. In the method for producing a polymer of the present embodiment, a polymer having a highly controlled composition and the like can be produced without utilizing those polymerization methods.

### (Post-Treatment)

As post-treatment after the second step, for example, the obtained polymer solution may be diluted with a good solvent to an appropriate solution viscosity as necessary, and then dropped into a large amount of a poor solvent (methanol, water, hexane, heptane or the like) to precipitate the polymer. The above-described step (generally referred to as reprecipitation) is effective for removing unreacted monomers, an unreacted polymerization initiator and the like which remain in the polymer solution. The unreacted substances, which may have an adverse effect on the performance of the polymer and the end use of the polymer, thus are preferably removed as much as possible. The reprecipitation step may be unnecessary.

Thereafter, the precipitate is separated by filtration, and sufficiently dried to obtain a polymer. The wet powder after the filtration may be used without being dried.

### Second Embodiment

The polymer production device 1B according to the embodiment, which is shown in FIG. 1B, includes three stirred tank reactors 20 (20a, 20b, 20c) as described above. While three stirred tank reactors 20a, 20b and 20c are shown in the figure, the number of stirred tank reactors 20 is not limited to 3, and may be 2, or 4 or more. The configuration of the device and the like located upstream from the tubular reactor 10, the configuration of the tubular reactor 10, the configurations of the stirred tank reactors 20 (20a, 20b, 20c), and the operations, conditions and the like thereof are as described in the first embodiment. Hereinafter, differences from the first embodiment will be mainly described.

In the flow channel through which the reaction liquid from the tubular reactor 10 flows, three-port valves V₂ₐ, V_{2b}, and V_{2c} are provided so as to correspond to the stirred tank reactors 20a, 20b and 20c, respectively. The stirred tank reactors 20a, 20b and 20c are independently charged with the reaction liquid depending on opening and closing of the three-port valves V₂ₐ, V_{2b} and V_{2c}, respectively. At the tip of the flow channel beyond the three-port valve V_{2c} (in the figure, an arrow extending rightward from the three-port valve V_{2c}), the flow channel may be connected to another three-port valve and a stirred tank reactor, or may be connected a reaction liquid recovery tank, or nothing may be provided (the three-port valve V_{2c} may be a terminus).

The polymer production device 1B includes a monomer tank 50 filled with a mixed solution containing monomers so that the monomers can be added independently in the second step. A metering pump 51 is provided in the flow channel extending from the monomer tank 50. Further, in the flow channel extending from the metering pump 51, three-port valves V₃ₐ, V_{3b}, and V_{3c} are provided so as to correspond to the stirred tank reactors 20a, 20b and 20c, respectively. The stirred tank reactors 20a, 20b and 20c are independently charged with the mixed solution of the monomers depending on opening and closing of the three-port valves V₃ₐ, V_{3b} and V_{3c}, respectively. The number of the monomer tanks 50 is not limited to 1, and two or more monomer tanks may be provided according to a type of monomer, and the like. At the tip of the flow channel beyond the three-port valve V_{3c} (in the figure, an arrow extending rightward from the three-port valve V_{3c}), the flow channel may be connected to a monomer solution recovery tank, or nothing may be provided (the three-port valve V_{3c} may be a terminus).

The polymer production device 1B includes a solvent tank 60 filled with a solvent so that the solvent can be added independently in the second step. A metering pump 61 is provided in the flow channel extending from the solvent tank 60. Further, in the flow channel extending from the metering pump 61, three-port valves V₄ₐ, V_{4b}, and V_{4c} are provided so as to correspond to the stirred tank reactors 20a, 20b and 20c, respectively. The stirred tank reactors 20a, 20b and 20c are independently charged with the solvent depending on opening and closing of the three-port valves V₄ₐ, V_{4b} and V_{4c}, respectively. The number of the solvent tanks 60 is not limited to 1, and two or more solvent tanks may be provided according to a type of solvent, and the like. At the tip of the flow channel beyond the three-port valve V_{4c} (in the figure, an arrow extending rightward from the three-port valve V_{4c}), the flow channel may be connected to a solvent recovery tank, or nothing may be provided (the three-port valve V_{4c} may be a terminus).

The polymer production device 1B shown in FIG. 1B includes the monomer tank 50 and the solvent tank 60, but instead thereof or together therewith, the polymer production device 1B may include an initiator tank which is filled with a solution containing an azo-based polymerization initiator in a solvent.

In the polymer production device 1B shown in FIG. 1B, three-port valves V₂ₐ to V_{2c}, V₃ₐ to V_{3c}, and V₄ₐ to V_{4c} corresponding to the tubular reactor 10, the monomer tank 50 and the solvent tank 60, respectively, are individually provided, and the three-port valves are controlled. The scheme of valves is not limited thereto, and a four-port two-way switching valve may be used. For example, instead of the three-port valves V₂ₐ to V_{2c}, three two-way switching valves may be provided, where a flow channel from the metering pump 61, which is connected to the solvent tank 60, is directly connected to each of the two-way switching valves (here, the valves V₄ₐ to V_{4c} are unnecessary). The two-way switching valve includes two switching patterns. That is, the first switching pattern switches between a flow channel through which a solvent from the metering pump 61 flows to the stirred tank reactor 20a and a flow channel through which a reaction liquid from the three-port valve 18 flows to a recovery tank (not shown). The second switching pattern switches between a flow channel through which a solvent from the metering pump 61 flows to a recovery tank (not shown) and a flow channel through which a reaction liquid from the three-port valve 18 flows to the stirred tank reactor 20a. A two-way switching valve may be appropriately utilizing by considering, for example, construction and control of an intended reaction system.

By individually controlling the flow rate of the reaction liquid from the tubular reactor 10, the time of opening and closing of the three-port valves V₂ₐ, V_{2b} and V_{2c}, the flow rate from the solvent tank 60 and the time of opening and closing of the three-port valves V₄ₐ, V_{4b} and V_{4c}, the relationships of the maximum solid content concentration C1ₘₐₓ and the maximum solid content concentration C2ₘₐₓ, C1ₘₐₓ>C2ₘₐₓ and C1ₘₐₓ=C2ₘₐₓ can be efficiently satisfied. The control of the flow rate and the time of opening and closing may be manually performed, may be automatically performed as programmed in advance, or may be performed in accordance with a process parameter determined by a later-described optimization system.

### <System for Optimizing Radical Polymerization Reaction>

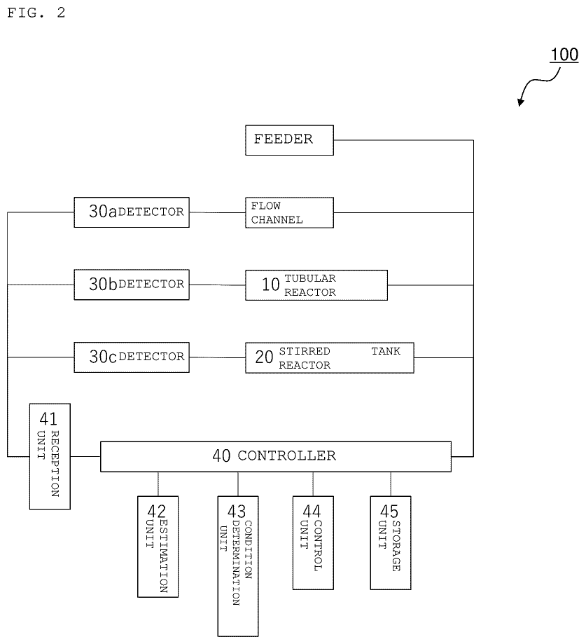

A system for optimizing a radical polymerization reaction according to the present embodiment will be described with reference to FIGS. 1A, 1B and 2. FIG. 2 is a block diagram schematically showing a system for optimizing a radical polymerization reaction. The optimization system can optimize a radical polymerization reaction in which a polymer is obtained by radical polymerization in a reaction liquid containing a polymerization initiator, a monomer and a solvent.

An optimization system 100 includes a flow channel through which a reaction liquid flows, and a feeder for supplying one or more of a polymerization initiator, a monomer and a solvent to the flow channel (corresponding to the initiator tank 11 and the monomer tank 12 in FIGS. 1A and 1B; hereinafter, sometimes referred to as “feeders 11 and 12” in the present specification), the tubular reactor 10 and the stirred tank reactor 20 interposed between the starting end and the terminal end of the flow channel and in the stated order from the starting end side, detectors 30a, 30b and 30c for acquiring one or more measured values for the reaction liquid in at least the flow channel, the tubular reactor 10 and the stirred tank reactor 20 (see FIG. 2; not shown in FIGS. 1A and 1B; hereinafter, sometimes referred to collectively as “detectors 30a to 30c”), and a controller 40 connected to the channel, the feeders 11 and 12, the tubular reactor 10, and the stirred tank reactor 20 to control one or more process parameters of each of the flow channel, the feeders 11 and 12, the tubular reactor 10 and the stirred tank reactor 20.

The controller 40 includes a reception unit 41 that receives measured values from the detectors 30a to 30c, an estimation unit 42 that estimates an actual progress state of the radical polymerization from the measured value, a condition determination unit 43 that compares the actual progress state and an ideal progress state, determines one or more process parameters in each of the flow channel, the feeders 11 and 12, the tubular reactor 10 and the stirred tank reactor 20 for a next unit reaction time so as to make the actual progress state close to the ideal progress state, and a control unit 44 that changes, in accordance with the determined process parameters, process parameters of the flow channel, the feeders 11 and 12, the tubular reactor 10 and the stirred tank reactor 20. It is preferable that the controller 40 further includes a storage unit 45 that stores the measured value, the actual progress state and a difference between the actual progress state and the ideal progress state before and after the process parameter is changed. The controller 40, the reception unit 41, the estimation unit 42, the condition determination unit 43, the control unit 44 and the storage unit 45 are implemented by an arbitrary combination of hardware and software which mainly includes CPU of an arbitrary computer, a memory, a computer program for implementing the constituent elements according to the present embodiment, which are loaded in the memory, a storage medium for storing the program, such as a hard disk, and an interface for network connection.

The flow channel, the feeders 11 and 12, the tubular reactor 10 and the stirred tank reactor 20 of the polymer production device 1 are as described in detail with reference to FIG. 1.

The detectors 30a to 30c measure the reaction liquid in the flow channel, the tubular reactor 10 and the stirred tank reactor 20, respectively, and acquire measured values. In the detectors 30a to 30c, the measured values may be acquired by in-line monitoring, may be acquired by sampling of the reaction liquid, or may be acquired by a combination of both. The detectors 30a to 30c are not particularly limited, and examples thereof include an infrared spectro(IR)-photometer, a near infrared spectro(NIR)-photometer, a Raman spectrophotometer, an ultraviolet-visible spectrophotometer, a polarimeter, a circular dichroism dispersion meter, a fluorospectrophotometer, a light scattering photometer, a nuclear magnetic resonance (NMR) apparatus, a high performance liquid chromatographic (HPLC) apparatus, a mass spectrometer, an optical oxygen densitometer, a particle size distribution meter, a viscometer, a kinematic viscometer, a densitometer, a potentiometric analyzer, an amperometric titrator, a coulometer, a conductometer, a polarographic analyzer, an electrolytic analyzer, a corona-charged particle detector, a camera, and a high-speed camera.

The measured value preferably includes at least one of an optical spectrum and a viscosity of the reaction liquid. These measured values have good correlation with the (actual) progress state of radical polymerization (in particular, the consumption of the monomer and the weight average molecular weight of the polymer), and enables the state of the reaction liquid to be assessed with high accuracy. As the detectors 30a to 30c, measuring instruments with which these measured values can be obtained may be selected.

The reception unit 41 receives the measured values from the detectors 30a to 30c, and the estimation unit 42 then estimates the actual progress state of the radical polymerization from the measured values. The actual progress state preferably includes at least one of the amount of consumption of a monomer and a weight average molecular weight of a polymer as described above.

The actual progress state can be preferably estimated by constructing, in advance, a regression model obtained by training with a data set in which a measured value for training is used as an independent variable and the actual progress state is used as a dependent variable, and applying the measured values acquired by the detectors 30a to 30c to the regression model.

For estimating the consumption of the monomer, for example, a linear regression model trained using a data set of monomer concentrations measured by HPLC and IR-measured spectra can be used. To the linear regression model constructed in this manner, measured values from detectors (infrared spectrophotometers) provided at the starting point and the terminal point of the tubular reactor 10 and inside the stirred tank reactor 20 are applied, and differences between the respective values are determined, whereby the consumption of the monomer can be estimated.

For estimating the weight average molecular weight of the polymer, for example, a linear regression model or a nonlinear regression model trained using a data set of polystyrene-equivalent weight average molecular weights of polymers measured by gel permeation chromatography (GPC), viscosity of reaction liquids with a viscometer, and compositions and concentrations of produced polymers which are calculated estimated values of consumptions of monomers can be used. To the linear regression model constructed in this manner, measured values from detectors (viscometers) provided at the starting point of the tubular reactor 10 and inside the stirred tank reactor 20 are applied, whereby the weight average molecular weight of the polymer can be estimated.

For other measured values indicating an actual progress state, estimation can be performed by constructing a regression model in the same manner as described above, and applying the acquired measured values to the regression model.

The constructed regression model and the data set for training may be stored in the storage unit 45, or may be stored in another hardware.

In the condition determination unit 43, the ideal progress state to be compared with the actual progress state can be appropriately set according to respective states of an intended monomer and polymer (a consumption of the monomer, a composition and a molecular weight of the polymer, and the like).

In the condition determination unit 43, the technique for making the actual progress state close to the ideal progress state is not particularly limited, but it is preferable that a condition setting algorism is used to calculate the change in the actual progress state in the next unit reaction time, which is caused by the change in the process parameter, thereby determining a process parameter. Examples of the condition setting algorithm include an experimental design method, Latin hypercube sampling, Bayesian optimization, linear regression, and nonlinear regression (Gaussian process regression, kernel method, neural network, regression tree and the like). In particular, the condition setting algorithm is preferably Bayesian optimization. A known condition setting algorithm may be used. For the Bayesian optimization, BoTorch which is a Python library can be preferably utilized.

When the actual progress state is a consumption of the monomer and a polymerization average molecular weight of the polymer, the estimated values of the consumption of the monomer and the polymerization average molecular weight of the polymer which are estimated by the estimation unit 42, and process parameters incorporating the estimated values are applied to Bayesian optimization to calculate a change in the actual progress state in the next unit reaction time, thereby determining process parameters. Specifically, a randomly selected initial point (initial process parameter) is generated, and a polymerization reaction is allowed to proceed in the polymer production device 1. Then, results (measured values) are acquired from the detectors 30a to 30c. On the basis of these results, a prediction model is prepared by Gaussian process regression, followed by calculation of a score in which a balance of exploitation and exploration is considered. A candidate point (process parameter) in the next unit reaction time is proposed. The polymerization reaction based on the candidate point is allowed to proceed again, and results are acquired. The results are added to the prepared prediction model to update the prediction model. By repeating the above procedure to update and learn the prediction model, the calculation of the process parameters can be optimized. In random selection of an initial point, it is preferable to prevent selection of a similar point (similar condition). For efficient random selection of the initial point, for example, a known program such as the Latin hypercube sampling can be used.

The process parameter preferably includes at least one of the temperature, the introduction amount of a monomer, the introduction amount of an azo polymerization initiator, the introduction amount of a solvent, and the stirring rate. The larger the number of process parameters, the more complicated the calculation in the condition setting algorithm. Therefore, the number of process parameters is preferably 1, 2 or 3, and more preferably 1 or 2. The process parameter is more preferably the temperature, the introduction amount of a monomer, and the introduction amount of an azo polymerization initiator.

The control unit 44 changes the process parameters of the flow channel, the feeders 11 and 12, the tubular reactor 10, and the stirred tank reactor 20 according to the process parameters determined by the condition determination unit 43.

The above procedure is repeated until the difference between the actual progress state and the ideal progress state is within an allowable range. In the repeating process, each of the measured values before and after the change of the process parameter, the actual progress state, and the difference between the actual progress state and the ideal progress state are stored in the storage unit 45, whereby a more efficient machine-learning optimization system of higher precision can be constructed.

The actuation of the controller 40 may be automatically performed in accordance with a preset program, or may be performed via an interface (not shown) in which the process parameter can be manually controlled.

### EXAMPLES

Next, the present invention will specifically be described on the basis of examples, but is not limited to these examples.

### [Example 1] Synthesis of Polymer (A-1)

A polymer was produced using a polymer production device 1 whose configuration is shown in FIG. 1. A total of 100 parts by mass of styrene (ST) as a monomer M1 and methyl methacrylate (MMA) as a monomer M2 (molar ratio: 50/50) were dissolved in 200 parts by mass of 1-methoxy-2-propanol (PGME) to prepare a monomer solution, which was stored in a monomer tank 12. Similarly, 12.2 parts by mass (5 mol % with respect to the total amount of monomers) of V-65 (manufactured by FUJIFILM Wako Pure Chemical Corporation) as an azo-based polymerization initiator was dissolved in 200 parts by mass of PGME to prepare a polymerization initiator solution, which was stored in an initiator tank 11.

In a tubular reactor 10, a PFA coiled tube (flow channel) 17 (length of immersion region in oil bath 16: 10 m, inner diameter: 1 mm) made was immersed in an oil bath to obtain a reaction region. The temperature of the oil bath 16 was adjusted to 60° C. and the temperature was maintained. The monomer solution and the polymerization initiator solution were continuously fed at flow rates of 1.57 mL/min and 1.57 mL/min with metering pumps 13a and 13b, respectively, so that a radical polymerization reaction proceeded in the coiled tube. The solid content concentration at a point from which the coiled tube (flow channel) 17 enters a reaction region (a gas-liquid interface in the oil bath) was 20 mass %. In the coiled tube, the valve opening degree on the outlet side was adjusted to so that a pressure gauge 15 on the sample introduction side indicated 0.0 MPa, followed by adjustment to a constant pressure. The flow rate in the coiled tube 17 was 3.14 mL/min, and the retention time in the coiled tube immersed in the oil bath 16 (that is the reaction time) was 10 minutes. The polymerization conversion after passage through the immersion region was 35%.

Subsequently, a thermometer-equipped three-necked flask (a stirred tank reactor) 20, which had a volume of 600 mL and in which a magnetic stirrer was placed as a stirring member and the atmosphere was purged with nitrogen gas, was continuously charged with 377 mL of the obtained reaction liquid. While temperature control was performed so that the temperature of the liquid inside the flask was 60° C. at a stirring rate of 400 rpm, the polymerization reaction was performed for 230 minutes from the reaction starting time point which was the time point at which the introduction of the reaction liquid was completed. After completion of the reaction, the polymerization conversion was 80%, and the solid content concentration was 20 mass %. Finally, the obtained polymer (A-1) solution was discharged from a discharge tube 23.

### [Examples 2 to 8 and Comparative Examples 1 to 6] Synthesis of Polymers (A-2) to (A-8) and (B-1) to (B-4)

Except that the operations and conditions in the first step and the second step were changed to those shown in Table 1, the same procedure as in Example 1 was carried out to obtain polymers (A-2) to (A-8) and polymers (B-1) to (B-4). In Table 1, “~” indicates that corresponding operations or evaluation was not performed. In Examples 7 and 8, the flask in the second step was charged with PGME as a solvent in an amount which ensured that
the value of the monomer concentration was as shown in Table 2. In Example 8, the first step, in which the molar concentration ratio of monomers was 49:51, was carried out, followed by the second step in which styrene as a monomer and 1-methoxy-2-propanol as a solvent were added, so that the molar concentration ratio of monomers was 50:50 (*1). In Comparative Example 3, in the second step, the temperature of the inside of the flask was raised from 30° C. to 60° C. at a temperature raising rate of 1° C./min, and the reaction was then performed further for 210 minutes, so that the total polymerization time was 240 minutes (*2). In Comparative Example 4, the first step was not carried out, and the raw material was dropped into the reactor over 180 minutes. After completion of the dropping, the reaction was performed further for 180 minutes, so that the total polymerization time was 360 minutes (*3).

### <Evaluation>

The monomer consumption rate ratios during the reaction and at the end of the reaction and the ratios of the weight average molecular weights at the end of the first step and at the end of the second step in Examples 1 to 8 and Comparative Examples 1 to 6 were determined. Further, the obtained polymers (A-1) to (A-8) and polymers (B-1) to (B-4) were evaluated as follows. The results are shown in Table 1 below.

### [Monomer Consumption Rate Ratio (M1 Conversion/M2 Conversion)]

Using a reverse-phase column (C-18) from Shimadzu Corporation, measurement was performed under analysis conditions of flow rate: 1.0 mL/min, elution solvent volume ratio: acetonitrile/ultrapure water=55/45, a sample concentration: 0.2 mass %, amount of sample injected: 1 μL, column temperature: 40° C., and detector: ultraviolet-visible spectrophotometer at a wavelength of 210 nm by high-performance liquid chromatography (HPLC) in which the concentrations of monomers were used for a calibration curve. It can be considered that when the ratio of the conversion of the monomer M1 to the conversion of the monomer M2 (M1 conversion/M2 conversion) is 0.9 or more and 1.1 or less, the consumption rates (conversions) of the monomers are equivalent, so that the structural units derived from the respective monomers are incorporated into the polymer more evenly.

### [Weight Average Molecular Weights (Mw) at End of First Step and at End of Second Step and Ratio of the Weight Average Molecular Weights]

Using GPC columns (G2000HXL×2, G3000HXL×1, and G4000HXL×1) manufactured by Tosoh Corporation, measurement was performed under analysis conditions of flow rate: 1.0 mL/min, elution solvent: THF, sample concentration: 1.0 mass %, amount of sample injected: 100 μL, column temperature: 40° C., and detector: differential refractometer by gel permeation chromatography (GPC) in which monodisperse polystyrene was used as a standard. It is considered that when the ratio of the weight average molecular weight Mw1 at the end of the first step to the weight average molecular weight Mw2 at the end of the second step (Mw1/Mw2) is 0.8 or more and 1.1 or less, the weight average molecular weight of the obtained polymer is close to a target value, which indicates a high molecular weight controllability property.

### [Amount of Remaining Metal]

The sample was diluted 50-fold with N-methyl-2-pyrrolidone containing nitric acid at a concentration of 2 mass %, and measurement was performed by dielectric coupled plasma mass spectrometry (7900 manufactured by Agilent Technologies Inc.) under the conditions of a torch for an organic solvent, a scan time of 0.5 seconds, and measurement elements of Li, Na, Mg, Al, K, Ca, Cr, Mn, Fe, Ni, Cu, Zn, Zr, Sn, Ti, Pb, Sb, Co, Ag, Cd, Ba, V, As and Au. When the total amount of detected elements is less than 10 ppb, it may be indicated that there were little metal impurities.

### [Amount of Remaining Sulfur]

10 μL of the sample solution was heated to 70° C., decompressed to 5 hPa, and dried, and measurement was performed with a fluorescent X-ray apparatus (NANOHUNTER II manufactured by Rigaku Corporation) under the analysis conditions of a tube voltage of 50 kV, a tube current of 12 mA, an incidence angle of 0.030 deg, a converging angle of 0.05 deg and a measurement time of 300 seconds. When the analysis value is less than 1 ppm, it may be indicated that there were little sulfur impurities.

TABLE 1

| | | | | First step (flow) | | | | Second step (batch) | | | |
|---|---|---|---|---|---|---|---|---|---|---|---|
| | | | | | Solid | | | | Solid | | |
| | | | | | content | | | | content | | |
| | | | | | concen- | | Polymer- | | concen- | | Polymer- |
| | | | | M1/M2* | tration | Temper- | ization | M1/M2 | tration | Temper- | ization |
| | | | | (mol %/ | C1 | ature | time | (mol %/ | C2 | ature | time |
| | | Polymer | Initiator | mol %) | (mass %) | T1 (° C.) | (min) | mol %) | (mass %) | T2 (° C.) | (min) |
| Example | 1 | A-1 | V-65 | 50/50 | 20 | 60 | 10 | 50/50 | 20 | 60 | 230 |
| | | | (5 mol %) | | | | | | | | |
| | 2 | A-2 | V-65 | 30/70 | 20 | 60 | 10 | 30/70 | 20 | 60 | 230 |
| | | | (5 mol %) | | | | | | | | |
| | 3 | A-3 | V-601 | 50/50 | 20 | 80 | 10 | 50/50 | 20 | 80 | 230 |
| | | | (5 mol %) | | | | | | | | |
| | 4 | A-4 | V-65 | 50/50 | 20 | 60 | 10 | 50/50 | 20 | 60 | 230 |
| | | | (5 mol %) | | | | | | | | |
| | 5 | A-5 | V-65 | 50/50 | 20 | 60 | 10 | 50/50 | 20 | 60 | 230 |
| | | | (5 mol %) | | | | | | | | |
| | 6 | A-6 | V-65 | 50/50 | 20 | 90 | 10 | 50/50 | 20 | 80 | 230 |
| | | | (4 mol %) | | | | | | | | |
| | 7 | A-7 | V-65 | 50/50 | 50 | 60 | 10 | 50/50 | 20 | 60 | 230 |
| | | | (5 mol %) | | | | | | | | |
| | 8 | A-8 | V-65 | 49/51 | 50 | 90 | 10 | 50/50 | 20 | 80 | 230 |
| | | | (5 mol %) | | | | | (*1) | | | |
| Comparative | 1 | B-1 | V-65 | 50/50 | 75 | 60 | 240 | — | — | — | — |
| Example | | | (5 mol %) | | | | | | | | |
| | 2 | B-2 | BPO | 50/50 | 25 | 90 | 240 | — | — | — | — |
| | | | (5 mol %) | | | | | | | | |
| | 3 | B-3 | V-65 | — | — | — | — | 50/50 | 20 | 30→60 | 240 |
| | | | (5 mol %) | | | | | | | (1° C./min) | |
| | | | | | | | | | | (*2) | |
| | 4 | B-4 | V-65 | — | — | — | — | 50/50 | 20 | 60 | 360 (*3) |
| | | | (5 mol %) | | | | | | | | |
| | 5 | B-5 | RAFT | — | — | — | — | 50/50 | 50 | 60 | 240 |
| | | | (1 mol %) | | | | | | | | |
| | | | V-65 | | | | | | | | |
| | | | (5 mol %) | | | | | | | | |
| | 6 | B-6 | V-65 | 50/50 | 25 | 60 | 10 | 50/50 | 25 | 80 | 230 |
| | | | (5 mol %) | | | | | | | | |

| | | Monomer | | Weight average | | | | |
|---|---|---|---|---|---|---|---|---|
| | | consumption | | molecular | | Ratio of | | |
| | | rate ratio | | weight | | weight | | |
| | | (M1 conversion/ | | Mw | | average | | |
| | | M2 conversion) | | | End of | molecular | | |
| | | | End of | 10 min | reaction | weight | Remaining | Remaining |
| | | 10 min | reaction | (Mw1) | (Mw2) | Mw1/Mw2 | metal | sulfur |
| Example | 1 | 1.04 | 1.01 | 3580 | 3640 | 0.98 | ∘ | ∘ |
| | 2 | 1.14 | 1.04 | 4400 | 4200 | 1.05 | ∘ | ∘ |
| | 3 | 1.11 | 1.02 | 4020 | 3750 | 1.07 | ∘ | ∘ |
| | | | | (1.18) | (1.10) | | | |
| | 4 | 1.08 | 1.01 | 4280 | 4000 | 1.07 | ∘ | ∘ |
| | | | | (0.94) | (0.88) | | | |
| | 5 | 1.11 | 1.02 | 4350 | 4170 | 1.04 | ∘ | ∘ |
| | | | | (0.79) | (0.76) | | | |
| | 6 | 1.09 | 1.02 | 3560 | 3620 | 0.98 | ∘ | ∘ |
| | | | | (1.05) | (1.06) | | | |
| | 7 | 1.01 | 1.01 | 3750 | 3700 | 1.01 | ∘ | ∘ |
| | | | | (1.10) | (1.09) | | | |
| | 8 | 1.02 | 1.01 | 3600 | 3600 | 1.00 | ∘ | ∘ |
| | | | | (1.06) | (1.06) | | | |
| Comparative | 1 | — | Unstable | 3760 | Unstable, | — | ∘ | ∘ |
| Example | | | (0.8-1.4) | (1.10) | 2000-10000 | | | |
| | 2 | — | 1.02 | 3920 | 3700 | 1.06 | x | ∘ |
| | | | | (1.15) | (1.09) | | | |
| | 3 | — | 1.21 | 16300 | 3900 | 4.18 | ∘ | ∘ |
| | | | | (4.80) | (1.15) | | | |
| | 4 | — | 1.18 | 1980 | 3660 | 0.54 | ∘ | ∘ |
| | | | | (0.58) | (1.08) | | | |
| | 5 | — | 1.03 | 1120 | 3720 | 0.30 | ∘ | x |
| | 6 | 1.14 | 1.04 | 17427 | 3320 | 5.25 | ∘ | ∘ |
| | | | | (5.12) | (0.98) | | | |

### [Example 9] Synthesis of Polymer (A-9)

A polymer was produced using a polymer production device 1 whose configuration is shown in FIG. 1. A total of 100 parts by mass of cyclohexyl methacrylate (CHMA) as a monomer M1 and methyl methacrylate (MMA) as a monomer M2 (molar ratio of M1/M2: 0.83) were mixed to prepare a mixed liquid of monomers, which was stored in a monomer tank 12. Similarly, 2.8 parts by mass (1.5 mol % with respect to the total amount of monomers) of V-65 (manufactured by FUJIFILM Wako Pure Chemical Corporation) as an azo-based polymerization initiator was dissolved in 100 parts by mass of PGME to prepare a polymerization initiator solution, which was stored in an initiator tank 11.

In a tubular reactor 10, a PFA coiled tube (flow channel) 17 (length of immersion region in oil bath 16: 10 m, inner diameter: 1 mm) made was immersed in an oil bath to obtain a reaction region. The temperature of the oil bath 16 was adjusted to 90° C. and the temperature was maintained. The mixed liquid of monomers and the polymerization initiator solution were continuously fed at flow rates of 6.1 mL/min and 6.5 mL/min with metering pumps 13a and 13b, respectively, so that a radical polymerization reaction proceeded in the coiled tube. The solid content concentration at a point from which the coiled tube (flow channel) 17 enters a reaction region (a gas-liquid interface in the oil bath) was 50 mass %. In the coiled tube, the valve opening degree on the outlet side was adjusted to so that a pressure gauge 15 on the sample introduction side indicated 0.0 MPa, followed by adjustment to a constant pressure. The flow rate in the coiled tube 17 was 12.6 mL/min, and the retention time in the coiled tube immersed in the oil bath 16 (that is the reaction time) was 2.5 minutes. The polymerization conversion after passage through the immersion region was 36%.

Subsequently, a thermometer-equipped three-necked flask (a stirred tank reactor) 20, which had a volume of 3,000 mL and in which a magnetic stirrer was placed as a stirring member and the atmosphere was purged with nitrogen gas, was charged with 1,500 mL of propylene glycol monomethyl ether as a solvent. Herein, 970 mL of the reaction liquid obtained using the tubular reactor 10 was continuously introduced. While temperature control was performed so that the temperature of the liquid inside the flask was 90° C. at a stirring rate of 600 rpm, the polymerization reaction was performed for 120 minutes from the reaction starting time point which was the time point at which the introduction of the reaction liquid was completed. After completion of the reaction, the polymerization conversion was 83%, and the solid content concentration was 20 mass %. During the polymerization reaction, the mixed liquid of monomers was appropriately added so that the ratio of the remaining monomers M1/M2 was constant. Finally, the obtained polymer (A-9) solution was discharged from a discharge tube 23.

### [Example 10] (Synthesis of Polymer (A-10))

Except that in the second step, the three-necked flask (stirred tank reactor) 20 was charged with 490 mL of propylene glycol monomethyl ether, the solid content concentration after completion of the reaction was set to 33.3 mass %, and the mixed liquid of monomers was not added, the same procedure as in Example 9 was carried out to obtain a polymer (A-10) solution.

### [Example 11](Synthesis of Polymer (A-11))

Except that in the second step, the three-necked flask (stirred tank reactor) 20 was not charged with propylene glycol monomethyl ether, the solid content concentration after completion of the reaction was set to 50 mass %, and the mixed liquid of monomers was not added, the same procedure as in Example 9 was carried out to obtain a polymer (A-11) solution.

### [Example 12] (Synthesis of Polymer (A-12))

Except that a mixed liquid of monomers was added, the same procedure as in Example 11 was carried out to obtain a polymer (A-12) solution.

### [Examples 13 to 16] Synthesis of Polymers (A-13) to (A-16)

Except that the three-necked flask (stirred tank reactor) 20 had a volume of 500 mL, and the addition of the mixed liquid of monomers was as in Table 2, the same procedure as in Example 11 was carried out to obtain polymer (A-13) to (A-16) solutions.

### <Evaluation>

The monomer consumption rate ratios during the reaction and at the end of the reaction and the ratios of the weight average molecular weights at the end of the first step and at the end of the second step in Examples 9 to 16 were determined by the methods described above. The evaluation results are shown in the following Table 2.

TABLE 2

| | | | | First step (flow) | | | | Second step (batch) | | |
|---|---|---|---|---|---|---|---|---|---|---|
| | | | | | Solid | | | | Solid | |
| | | | | | content | | | | content | |
| | | | | | concen- | | Polymer- | | concen- | |
| | | | | M1/M2 | tration | Temper- | ization | M1/M2 | tration | Monomer |
| | | | | (mol %/ | C1 | ature | time | (mol %/ | C2 | added |
| | | Polymer | Initiator | mol %) | (mass %) | T1 (° C.) | (min) | mol %) | (mass %) | or not |
| Example | 9 | A-9 | V-65 | 0.83 | 50 | 90 | 2.5 | 0.83 | 20 | Added |
| | 10 | A-10 | V-65 | 0.89 | 50 | 90 | 2.5 | 0.89 | 33.3 | None |
| | 11 | A-11 | V-65 | 0.89 | 50 | 90 | 2.5 | 0.89 | 50 | None |
| | 12 | A-12 | V-65 | 0.89 | 50 | 90 | 2.5 | 0.89 | 50 | Added |
| | 13 | A-13 | V-65 | 0.79 | 50 | 90 | 2.5 | 0.79 | 50 | None |
| | 14 | A-14 | V-65 | 0.79 | 50 | 90 | 2.5 | 0.79 | 50 | None |
| | 15 | A-15 | V-65 | 0.79 | 50 | 90 | 2.5 | 0.79 | 50 | None |
| | 16 | A-16 | V-65 | 0.79 | 50 | 90 | 2.5 | 0.79 | 50 | Added |

| | | | | | | Weight average | | |
|---|---|---|---|---|---|---|---|---|
| | | | | Monomer consumption | | molecular | | |
| | | | | rate ratio | | weight | | Ratio of |
| | | Second step (batch) | | (M1 conversion/ | | Mw | | weight |
| | | | Polymer- | M2 conversion) | | End of | | average |
| | | Temper- | ization | End of | | flow | End of | molecular |
| | | ature | time | flow | End of | (2.5 min) | reaction | weight |
| | | T2 (° C.) | (min) | (2.5 min) | reaction | (Mw1) | (Mw2) | Mw1/Mw2 |
| Example | 9 | 90 | 120 | 1.15 | 1.06 | 6710 | 8270 | 0.81 |
| | 10 | 90 | 120 | 1.13 | 1.08 | 6650 | 6800 | 0.98 |
| | 11 | 90 | 120 | 1.12 | 1.04 | 6690 | 7450 | 0.90 |
| | 12 | 90 | 120 | 1.1 | 1.02 | 6600 | 7860 | 0.84 |
| | 13 | 90 | 120 | 1.23 | 1.06 | 7180 | 7920 | 0.91 |
| | 14 | 90 | 120 | 1.29 | 1.06 | 7140 | 8010 | 0.89 |
| | 15 | 90 | 120 | 1.25 | 1.05 | 6990 | 7610 | 0.92 |
| | 16 | 90 | 120 | 1.34 | 1.02 | 7330 | 8580 | 0.85 |

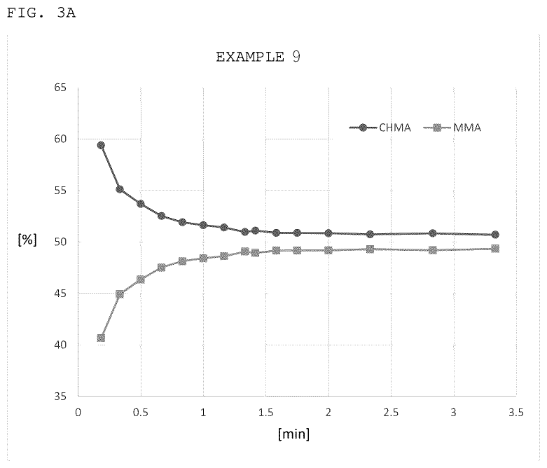

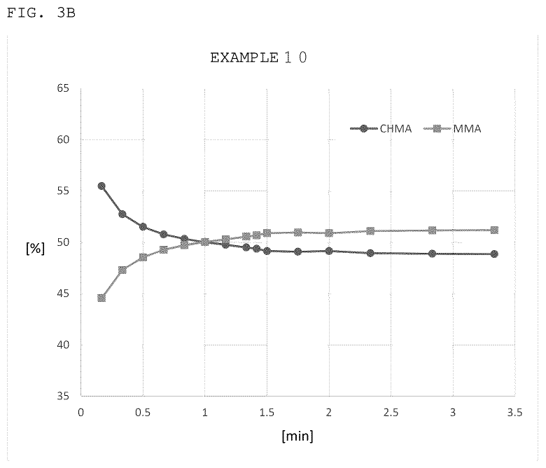

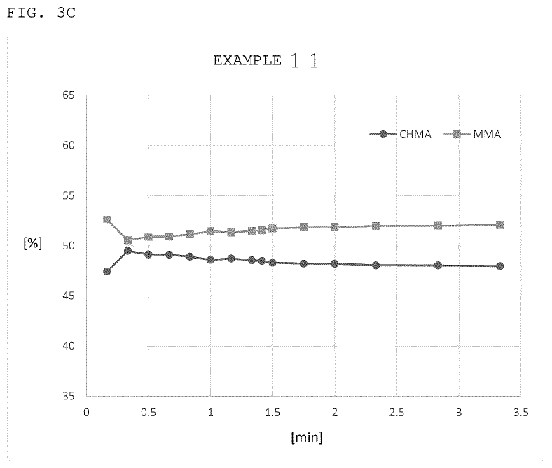

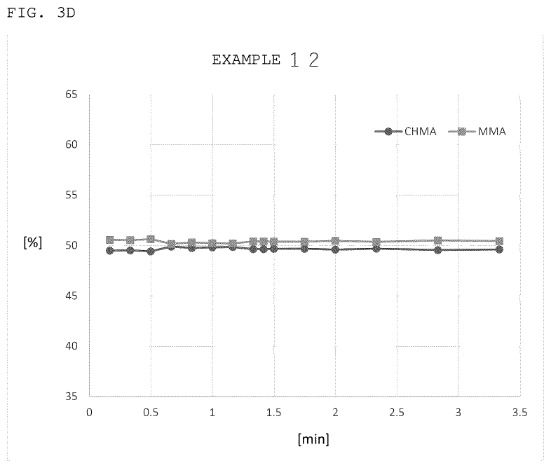

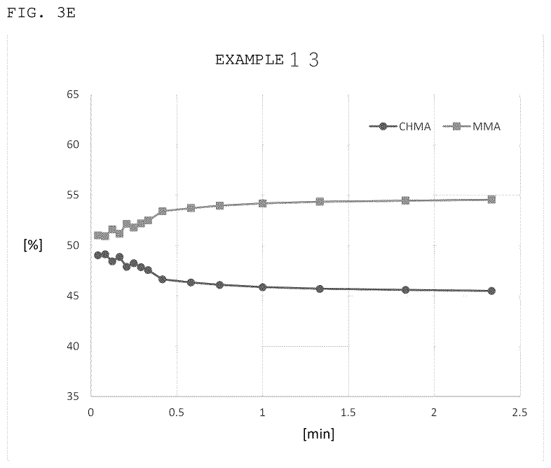

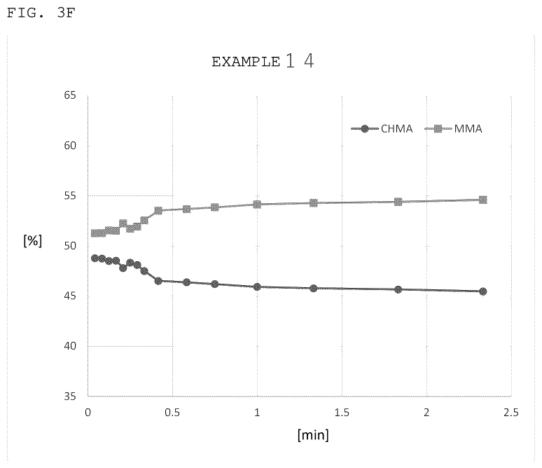

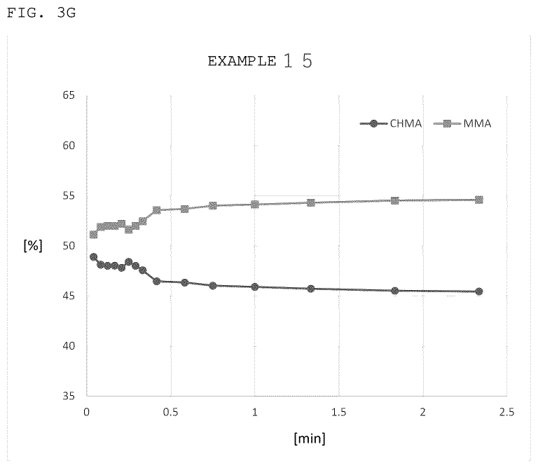

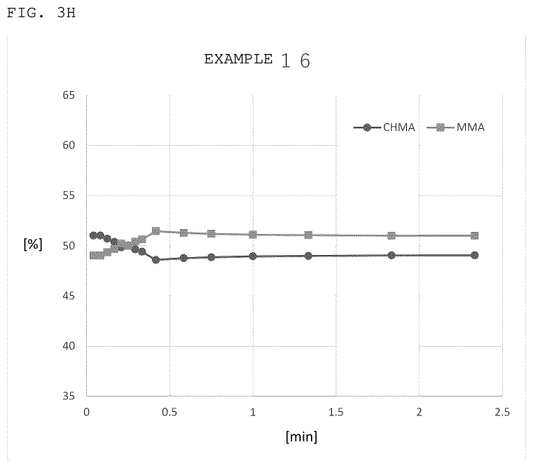

The composition ratio of the monomer M1 (CHMA) and the monomer M2 (MMA) in the system until lapse of a predetermined time immediately after the reaction solution was introduced into the second step was determined by HPLC measurement of the monomer consumption rate ratio. The evaluation results are shown in FIGS. 3A to 3H. In FIGS. 3A to 3H, the horizontal axis represents a time (min), and the vertical axis represents a ratio (%). It is shown that by directly introducing the reaction liquid from the first step into the second step, a change in concentration of the monomer can be suppressed, and good results were obtained for both the monomer consumption rate ratio and the ratio of weight average molecular weights.

### INDUSTRIAL APPLICABILITY

By the method for producing a polymer and the polymer production device according to the present invention, a polymer having a high purity and a highly controlled composition and the like can be efficiently produced. Therefore, the present invention is useful in technical fields where a polymer as a high-added value material is used.

### DESCRIPTION OF REFERENCE SIGNS

1, 1B Polymer production device
10 Tubular reactor
11 Polymerization initiator tank
12, 50 Monomer tank
13a, 13b, 51, 61 Metering pump
14 Collecting tube
15 Pressure gauge
16 Oil bath
17 Coiled flow channel
18, V₂ₐ, V_{2b}, V_{2c}, V₃ₐ, V_{3b}, V_{3c}, V₄ₐ, V_{4b}, V_{4c} Three-port valve
19 Discharge port
20, 20a, 20b, 20c Stirred tank reactor
21 Tank-shaped container
22 Stirring blade
23 Discharge tube
30a, 30b, 30c, 30d Detector
40 Controller
41 Reception unit
42 Estimation unit
43 Condition determination unit
44 Control unit
45 Storage unit
60 Solvent tank
100 Optimization system

1: A method for producing a polymer, the method comprising:
performing a first radical polymerization of two or more monomers with an azo-based polymerization and a solvent in a tubular reactor; and
performing a second radical polymerization in a stirred tank reactor after the first radical polymerization, wherein
a maximum solid content concentration C1ₘₐₓ on a mass basis in the first radical polymerization is 20 mass % or more,
a maximum solid content concentration C2ₘₐₓ on a mass basis in the second radical polymerization is less than 80 mass %,
the maximum solid content concentration C1ₘₐₓ and the maximum solid content concentration C2ₘₐₓ satisfy C1ₘₐₓ≥C2ₘₐₓ, and
a temperature T1 [° C.] in the tubular reactor in the first radical polymerization and a temperature T2 [° C.] in the stirred tank reactor in the second radical polymerization satisfy |T1−T2|<20.

2: The method for producing a polymer according to claim 1, wherein the maximum solid content concentration C1ₘₐₓ and the maximum solid content concentration C2ₘₐₓ satisfy C1ₘₐₓ>C2ₘₐₓ.

3: The method for producing a polymer according to claim 1, wherein a polymerization conversion in the first radical polymerization is 80% or less.

4: The method for producing a polymer according to claim 1, wherein the temperature T1 [° C.] and the temperature T2 [° C.]satisfy |T1−T2|<10.

5: The method for producing a polymer according to claim 4, wherein the temperature T1 [° C.] and the temperature T2 [° C.]satisfy T1≥T2.

6: The method for producing a polymer according to claim 1, wherein the monomer is two or more selected from the group consisting of one or more monomers which are (meth)acrylic acid or esters thereof, and one or more aromatic vinyl-based monomers.

7: The method for producing a polymer according to claim 6, wherein the monomer is one or more monomers which are (meth)acrylic acid or esters thereof, and one or more aromatic vinyl-based monomers.

8: The method for producing a polymer according to claim 1, wherein the radical polymerization is performed without a dormant species.

9: The method for producing a polymer according to claim 1, wherein the maximum solid content concentration C1ₘₐₓ and the maximum solid content concentration C2ₘₐₓ satisfy C1ₘₐₓ=C2ₘₐₓ.

10: A polymer production device for obtaining a polymer by radical polymerization of two or more monomers in a reaction liquid which comprises an azo-based polymerization initiator, the two or more monomers, and a solvent, the polymer production device comprising:
a tubular reactor; and
a stirred tank reactor connected to the tubular reactor and positioned at a downstream side of a flow path of the reaction liquid, each of the tubular reactor and the stirred tank reactor being configured to perform the radical polymerization,
wherein
a maximum solid content concentration C1ₘₐₓ on a mass basis in the tubular reactor is 30 mass % or more,
a maximum solid content concentration C2ₘₐₓ on a mass basis in the stirred tank reactor is less than 50 mass %,
the maximum solid content concentration C1ₘₐₓ and the maximum solid content concentration C2ₘₐₓ satisfy C1ₘₐₓ≥C2ₘₐₓ, and
a temperature T1 [° C.] in the tubular reactor during the radical polymerization and a temperature T2 [° C.] in the stirred tank reactor during the radical polymerization satisfy |T1−T2|<20.

11: A system for optimizing a radical polymerization reaction in which a polymer is obtained by radical polymerization of a monomer in a reaction liquid comprising a polymerization initiator, the monomer, and a solvent, the system comprising:
a flow channel through which the reaction liquid flows;
a feeder configured to supply one or more of the polymerization initiator, the monomer, and the solvent to the flow channel;
a tubular reactor and a stirred tank reactor interposed between a starting end and a terminal end of the flow channel with the tubular reactor on a side of the starting end and the stirred tank reactor on a side of the terminal end;
a detector configured to acquire one or more measured values for the reaction liquid in at least the flow channel, the tubular reactor and the stirred tank reactor; and
a controller connected to the flow channel, the feeder, the tubular reactor and the stirred tank reactor, and configured to control one or more process parameters of each of the flow channel, the feeder, the tubular reactor and the stirred tank reactor,
the controller comprising:
a reception unit configured to receive the measured value from the detector;
an estimation unit configured to estimate an actual progress state of the radical polymerization from the measured value;
a condition determination unit configured to compare the actual progress state and an ideal progress state, and determine one or more process parameters in each of the flow channel, the feeder, the tubular reactor and the stirred tank reactor for a next unit reaction time so as to make the actual progress state close to the ideal progress state; and
a control unit configured to change, in accordance with the determined process parameters, process parameters of the flow channel, the feeder, the tubular reactor and the stirred tank reactor.

12: The system for optimizing a radical polymerization reaction according to claim 11, wherein the condition determination unit configured to determine a process parameter by using a condition setting algorism to calculate the change in the actual progress state in the next unit reaction time, which is caused by the change in the process parameter.

13: The system for optimizing a radical polymerization reaction according to claim 11, wherein the controller further comprises a storage unit configured to store the measured value, the actual progress state and a difference between the actual progress state and the ideal progress state before and after the process parameter is changed.

14: The system for optimizing a radical polymerization reaction according to claim 11, wherein the measured value is acquired by in-line monitoring or sampling of the reaction liquid.

15: The system for optimizing a radical polymerization reaction according to claim 11, wherein the controller comprises an interface in which the process parameter can be manually controlled.

16: The system for optimizing a radical polymerization reaction according to claim 11, wherein the measured value comprises at least one of an optical spectrum and a viscosity of the reaction liquid.

17: The system for optimizing a radical polymerization reaction according to claim 11, wherein the process parameter comprises at least one of a temperature, an introduction amount of a monomer, an introduction amount of an azo polymerization initiator, an introduction amount of a solvent, and a stirring rate.

18: The system for optimizing a radical polymerization reaction according to claim 11, wherein the actual progress state comprises at least one of an amount of consumption of a monomer and a weight average molecular weight of a polymer.
